(19) United States
(12) Patent Application Publication
(10) Pub. No.: US 2011/0197156 A1
(43) Pub. Date: Aug. 11, 2011

(54) SYSTEM AND METHOD OF PROVIDING AN INTERACTIVE ZOOM FRAME INTERFACE

(75) Inventors: John Strait, Pittsburgh, PA (US); Dan Sweeney, Pitttsburgh, PA (US); Jason McCullough, Pittsburgh, PA (US)

(73) Assignee: DYNAVOX SYSTEMS, LLC, Pittsburgh, PA (US)

(21) Appl. No.: 12/702,440

(22) Filed: Feb. 9, 2010

(51) Int. Cl. G06F 3/048

(52) U.S. Cl. 715/771; 715/764

(57) ABSTRACT

Systems and methods for generating an interactive zoom interface for an electronic device include electronically displaying a first graphical user interface area to a user. Input is then received from a user indicating a desire to initiate a magnified or zoomed display state. Upon receipt of such electronic input, a second user interface area is displayed to a user. The second user interface area (i.e., a zoom frame) corresponds to a magnified view of some or all of the first user interface area, which may be displayed in place of or overlaid on some or all of the first user interface area. The second user interface area may include at least one zoom toolbar portion including selectable controls such as but not limited to one or more of a zoom in, zoom out, zoom amount, pan directions, scroll directions, cancel/dismiss, contrast and display options, zoom frame toolbar position options, etc.

### CROSS-REFERENCE TO RELATED APPLICATIONS

N/A

### STATEMENT REGARDING FEDERALLY SPONSORED RESEARCH OR DEVELOPMENT

N/A

### BACKGROUND

The presently disclosed technology generally pertains to systems and methods for providing alternative and augmentative (AAC) steps and features such as may be available in a speech generation device or other electronic device.

Electronic devices such as speech generation devices (SGDs) or Alternative and Augmentative Communication (AAC) devices can include a variety of features to assist with a user's communication. Such devices are becoming increasingly advantageous for use by people suffering from various debilitating physical conditions, whether resulting from disease or injuries that may prevent or inhibit an afflicted person from audibly communicating. For example, many individuals may experience speech and learning challenges as a result of pre-existing or developed conditions such as autism, ALS, cerebral palsy, stroke, brain injury and others. In addition, accidents or injuries suffered during armed combat, whether by domestic police officers or by soldiers engaged in battle zones in foreign theaters, are swelling the population of potential users. Persons lacking the ability to communicate audibly can compensate for this deficiency by the use of speech generation devices.

In general, a speech generation device may include an electronic interface with specialized software configured to permit the creation and manipulation of digital messages that can be translated into audio speech output or other outgoing communication such as a text message, phone call, e-mail or the like. Messages and other communication generated, analyzed and/or relayed via an SGD or AAC device may often include symbols and/or text alone or in some combination. In one example, messages may be composed by a user by selection of buttons, each button corresponding to a graphical user interface element composed of some combination of text and/or graphics to identify the text or language element for selection by a user.

In order to facilitate selection of the graphical user interface elements, including buttons, text, symbols or other items, some users may need or prefer the option to zoom into certain areas of a user display so that they can make selections from the zoomed area. Such a zooming option may be critical for a user with disabilities including vision impairment to be able to interact with and utilize an SGD or AAC device. In addition, users having motor control limitations may not be able to make touch selections on a display unless a larger selection area is presented.

However, conventional zoom features often provide somewhat limited functionality in implementing zooming options. In one known example, zoom features are configured in an all or nothing approach such that a user can only go from an initial display state to a fixed zoom state. Once in the fixed zoom state, a user can only select from within that state or cancel the state. If the zoom state is not big enough or doesn't capture an intended target, the user does not have any options for adapting the zoom state.

In light of the specialized utility of speech generation devices and related interfaces for users having various levels of potential disabilities, a need continues to exist for refinements and improvements to the zoom interface options for such devices. While various implementations of speech generation devices and associated zooming features have been developed, no design has emerged that is known to generally encompass all of the desired characteristics hereafter presented in accordance with aspects of the subject technology.

### BRIEF SUMMARY

In general, the present subject matter is directed to various exemplary speech generation devices (SGDs) or other electronic devices having improved configurations for providing selected AAC features and functions to a user. More specifically, the present subject matter provides improved features and steps for generating an interactive zoom frame interface for an electronic device, such as a speech generation device.

In one exemplary embodiment, a method of generating an interactive zoom interface for an electronic device includes a first step of electronically displaying a first graphical user interface area to a user. A second step involves receiving input from a user indicating a desire to initiate a magnified or zoomed display state. Upon receipt of such electronic input, a second user interface area is displayed to a user. The second user interface area (i.e., a zoom frame) corresponds to a magnified view of some or all of the first user interface area. The second user interface area may be displayed in place of or overlaid on some or all of the first user interface area. The second user interface area may include at least one zoom toolbar portion including selectable controls such as but not limited to one or more of a zoom in, zoom out, zoom amount, pan directions, scroll directions, cancel/dismiss, contrast and display options, zoom frame toolbar position options, and the like.

It should be appreciated that still further exemplary embodiments of the subject technology concern hardware and software features of an electronic device configured to perform various steps as outlined above. For example, one exemplary embodiment concerns a computer readable medium embodying computer readable and executable instructions configured to control a processing device to implement the various steps described above or other combinations of steps as described herein.

In a still further example, another embodiment of the disclosed technology concerns an electronic device, such as but not limited to a speech generation device, including such hardware components as a processing device, at least one input device and at least one output device. The at least one input device may be adapted to receive electronic input from a user regarding selection or identification of various zoom frame settings, as well as input from a user indicating the user's desire to initiate a zoom frame interface. The processing device may include one or more memory elements, at least one of which stores computer executable instructions for execution by the processing device to act on the data stored in memory. The instructions adapt the processing device to function as a special purpose machine that electronically analyzes the received user input and switches displays from the first user interface to the second user interface displayed over the first user interface or as part of the first user interface area. Again, such second user interface area (i.e., a zoom frame) corresponds to a magnified view of some or all of the first user interface area. The second user interface area may be displayed in place of or overlaid on some or all of the first user interface area. The second user interface area may include at least one zoom toolbar portion including selectable controls such as but not limited to one or more of a zoom in, zoom out, zoom amount, pan directions, scroll directions, cancel/dismiss, contrast and display options, zoom frame toolbar position options, and the like.

Additional aspects and advantages of the disclosed technology will be set forth in part in the description that follows, and in part will be obvious from the description, or may be learned by practice of the technology. The various aspects and advantages of the present technology may be realized and attained by means of the instrumentalities and combinations particularly pointed out in the present application.

### BRIEF DESCRIPTION OF THE DRAWINGS

The accompanying drawings, which are incorporated in and constitute a part of this specification, illustrate one or more embodiments of the presently disclosed subject matter. These drawings, together with the description, serve to explain the principles of the disclosed technology but by no means are intended to be exhaustive of all of the possible manifestations of the present technology.

FIG. 1 provides a flow chart of exemplary steps in a method of generating a zoom frame interface in accordance with aspects of the presently disclosed technology;

FIG. 2A depicts an exemplary embodiment of a first graphical user interface area in accordance with aspects of the present technology;

FIG. 2B depicts an exemplary embodiment of a second graphical user interface area (i.e., a zoom frame) displayed in place of the first graphical user interface area;

FIG. 2C depicts another exemplary embodiment of a second graphical user interface area (i.e., a zoom frame) displayed over a portion of the first graphical user interface area;

FIG. 3A depicts an exemplary embodiment of a second graphical user interface area (i.e., a zoom frame) having a first exemplary zoom toolbar position configuration;

FIG. 3B depicts an exemplary embodiment of a second graphical user interface area (i.e., a zoom frame) having a second exemplary zoom toolbar position configuration;

FIG. 4 depicts an exemplary embodiment of a graphical user interface menu for selecting zoom frame settings in accordance with aspects of the present technology; and

FIG. 5 provides a schematic view of exemplary hardware components for use in an exemplary speech generation device having zoom frame features in accordance with aspects of the presently disclosed technology.

### DETAILED DESCRIPTION OF THE PREFERRED EMBODIMENTS

Reference now will be made in detail to the presently preferred embodiments of the disclosed technology, one or more examples of which are illustrated in the accompanying drawings. Each example is provided by way of explanation of the technology, which is not restricted to the specifics of the examples. In fact, it will be apparent to those skilled in the art that various modifications and variations can be made in the present subject matter without departing from the scope or spirit thereof. For instance, features illustrated or described as part of one embodiment, can be used on another embodiment to yield a still further embodiment. Thus, it is intended that the presently disclosed technology cover such modifications and variations as may be practiced by one of ordinary skill in the art after evaluating the present disclosure. The same numerals are assigned to the same or similar components throughout the drawings and description.

The technology discussed herein makes reference to processors, servers, memories, databases, software applications, and/or other computer-based systems, as well as actions taken and information sent to and from such systems. The various computer systems discussed herein are not limited to any particular hardware architecture or configuration. Embodiments of the methods and systems set forth herein may be implemented by one or more general-purpose or customized computing devices adapted in any suitable manner to provide desired functionality. The device(s) may be adapted to provide additional functionality, either complementary or unrelated to the present subject matter. For instance, one or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, as will be understood by those of ordinary skill in the art without required additional detailed discussion, some embodiments of the methods and systems set forth and disclosed herein also may be implemented by hard-wired logic or other circuitry, including, but not limited to application-specific circuits. Of course, various combinations of computer-executed software and hard-wired logic or other circuitry may be suitable, as well.

It is to be understood by those of ordinary skill in the art that embodiments of the methods disclosed herein may be executed by one or more suitable computing devices that render the device(s) operative to implement such methods. As noted above, such devices may access one or more computer-readable media that embody computer-readable instructions which, when executed by at least one computer, cause the at least one computer to implement one or more embodiments of the methods of the present subject matter. Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other solid-state memory devices, and the like.

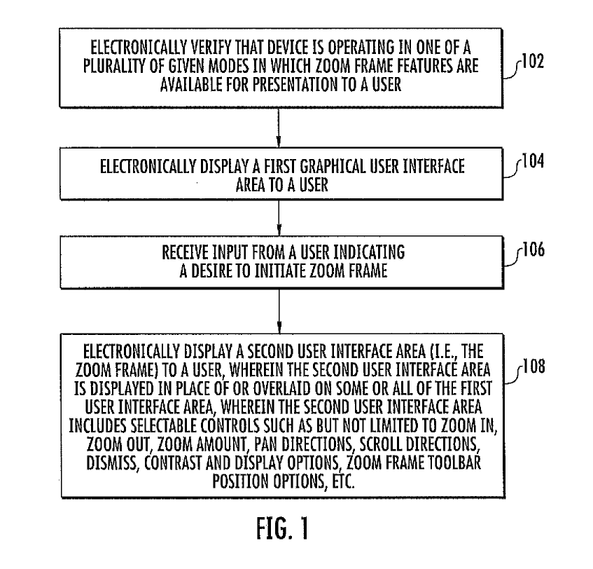

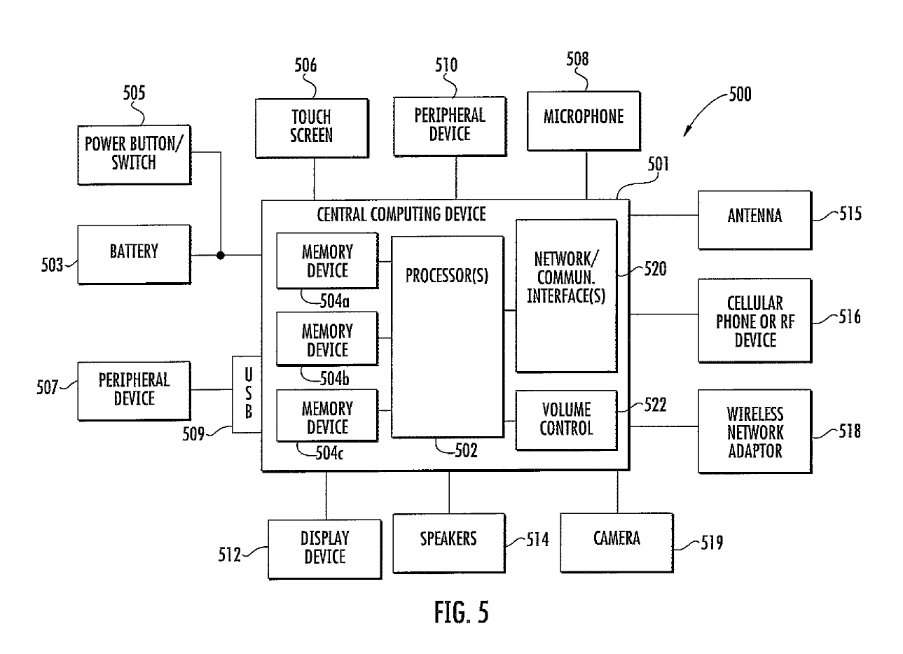

Referring now to the drawings, FIG. 1 provides a schematic overview of an exemplary method of generating a zoom frame interface for an electronic device in accordance with aspects of the presently disclosed technology. The steps provided in FIG. 1 may be performed in the order shown in such figure or may be modified in part, for example to exclude optional or non-optional steps or to perform steps in a different order than shown in FIG. 1. The steps shown in FIG. 1 are part of an electronically-implemented computer-based algorithm. Computerized processing of electronic data in a manner as set forth in FIG. 1 may be performed by a special-purpose machine corresponding to some computer processing device configured to implement such algorithm. Additional details regarding the hardware provided for implementing such computer-based algorithm are provided in FIG. 5.

A first exemplary step 102 in the method of FIG. 1 is an optional step of electronically verifying that an electronic device such as a speech generation device is operating in one or more of a plurality of given modes in which zoom frame features are configured for availability to a user. A speech generation device may often have the potential to operate in a variety of input/selection/access modes to accommodate the needs and preferences of users having varied types of abilities and access limitations. In one example, a speech generation device may be configured for operation in a first plurality of different modes or access methods, including but not limited to a “Touch Enter”, “Touch Exit,” “Touch Auto Zoom,” “Scanning,” “Joystick,” “Auditory Touch,” “Mouse Pause/Headtrackers,” “Morse Code” and/or “Eye Tracking” access methods. The electronic verification of step 102 may then involve verifying that the device is operating in one or more of a second plurality of modes, where the second plurality of modes is a subset of the first plurality of modes. In one example, the subset corresponding to the second plurality of different modes corresponds to “Touch Enter,” “Touch Exit,” “Auditory Touch,” “Mouse Pause” and “Eye Tracking.”

Additional details regarding the exemplary modes or access methods of a speech generation device are now presented. In a “Touch Enter” access method, selection is made upon contact with the touch screen, with highlight and bold options to visually indicate selection. In a “Touch Exit” method, selection is made upon release as a user moves from selection to selection by dragging a finger as a stylus across the screen. In a “Touch Auto Zoom” method, a portion of the screen that was selected is automatically enlarged for better visual recognition by a user. In a “Scanning” mode, highlighting is used in a specific pattern so that individuals can use a switch (or other device) to make a selection when the desired object is highlighted. Selection can be made with a variety of customization options such as a 1-switch autoscan, 2-switch directed scan, 2-switch directed scan, 1-switch directed scan with dwell, inverse scanning, and auditory scanning. In a “Joystick” mode, selection is made with a button on the joystick, which is used as a pointer and moved around the touch screen. Users can receive audio feedback while navigating with the joystick. In an “Auditory Touch” mode, the speed of directed selection is combined with auditory cues used in the “Scanning” mode. In the “Mouse Pause/Headtrackers” mode, selection is made by pausing on an object for a specified amount of time with a computer mouse or track ball that moves the cursor on the touch screen. An external switch exists for individuals who have the physical ability to direct a cursor with a mouse, but cannot press down on the mouse button to make selections. A “Morse Code” option is used to support one or two switches with visual and audio feedback. In “Eye Tracking” modes, selections are made simply by gazing at the device screen when outfitted with eye controller features and implementing selection based on dwell time, eye blinking or external switch activation.

Referring again to FIG. 1, a second step in an exemplary method of generating a zoom frame interface for an electronic device includes a step 104 of electronically displaying a first graphical user interface area to a user. Such first graphical user interface may correspond to any interface that may be implemented on an electronic device to facilitate a user's communication and interaction. For example, one graphical user interface may correspond to a standard keyboard or other customized keypad configured with keys, buttons or other interface elements that are selectable by a user depending on the type of access method(s) implemented by the user for the electronic device. Various other visual elements may be provided on a graphical user interface, including but not limited to text, symbols, icons, menus, templates, so-called “buttons” or other features. Other examples of a first graphical user interface correspond to a web browser, operating system desktop with icons or other interface elements, or any other preconfigured or customized interface created by a user or provided by a third party application configured for operation on one of the subject devices.

Graphical user interface elements are displayed on an output device (e.g., a touchscreen or other display) for selection by a user (e.g., via an input device, such as a mouse, keyboard, touchscreen, eye gaze controller, virtual keypad or the like). When selected, the user input features can trigger control signals that can be relayed to the central computing device within an SGD to perform an action in accordance with the selection of the user buttons. Such additional actions may result in execution of additional instructions, display of new or different user interface elements, or other actions as desired. As such, user interface elements also may be viewed as display objects, which are graphical representations of system objects that are selectable by a user. Some examples of system objects include device functions, applications, windows, files, alerts, events or other identifiable system objects.

In some exemplary embodiments, graphical user interfaces that include icons or buttons are configured with combinations of text and/or graphics in a single representation. For example, a button representing the word “baseball” can include the word as well as a graphic image of a baseball. Such integrated representations can be especially useful for displaying language elements within a graphical user interface. Language elements can be selected by a user of a speech generation device to compose messages that may then be “spoken” by the device or communicatively relayed via text message, e-mail or the like. Speaking consists of playing a recorded message or sound or speaking text using a voice synthesizer. In accordance with such functionality, some user interfaces are provided with a “Message Window” in which a user provides text, symbols corresponding to text, and/or related or additional information which then may be interpreted by a text-to-speech engine and provided as audio output via device speakers.

Referring again to FIG. 1, a next exemplary step in the method of generating a zoom frame interface for an electronic device includes a step 106 of receiving input from a user indicating a desire to initiate zoom frame. Such input may correspond to user selection of a button, icon or other graphical feature or selectable input which may be received to trigger a control signal by which an electronic device will actually display a zoom frame. Initiation of the zoom frame by a user's actuation signal may be provided by any one of the previously described access modes to select a preconfigured button, icon or other graphical feature.

Once a zoom actuation signal is received in step 106, step 108 then involves electronically displaying a second user interface (i.e., the zoom frame) to a user. The manner in which the second user interface area is displayed relative to the first user interface area may vary. For example, the second user interface area may be displayed in place of the first user interface area such that it fills an entire screen of a display device or the like. In another example, the second user interface may be displayed over some portion of the first user interface area. A screen may also be split to show both the first and second user interfaces either side by side, an top of one another, in a corner/L-shape arrangement, a picture-in-picture arrangement or other configuration. For users who cannot access the entire screen, the zoom frame can be reduced to an L shape and be presented in any one of the four corners of a display screen.

As a part of the second user interface area, selectable controls for the zoom frame shown therein are preferably provided. For example, the second user interface area may include selectable controls such as but not limited to zoom in, zoom out, zoom amount (percentage, size, amount, etc.) pan directions (up, down, left, right, etc.), scroll directions (up, down, left, right, etc.), a control to dismiss or cancel the zoom frame and return to the first graphical user interface, settings to control or set the contrast or other display settings, zoom frame toolbar position options, etc.

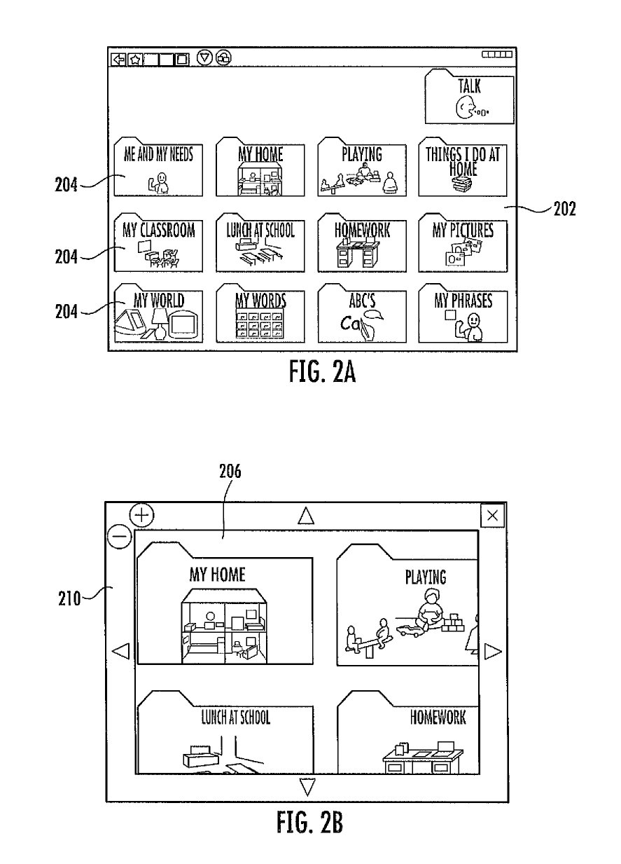

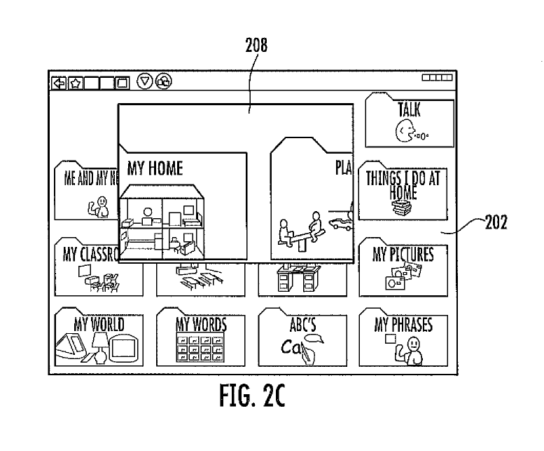

Referring now to FIGS. 2A-2C, exemplary first and second graphical user interfaces are depicted relative to one another in accordance with one embodiment of the present technology. FIG. 2A shows an example of a first graphical user interface 202 which generally corresponds to a display area with a plurality of selectable display elements 204. In the embodiment of FIG. 2A, display elements 204 correspond to selectable file folders, each having a button-like representation including a text and symbol identifier. Upon selection of one of the button-like display elements 204, a user may then be shown a subsequent graphical user interface having language elements stored within each selectable folder.

Some users may have trouble selecting a display element 204 within the first graphical user interface 202 or may simply prefer to have such display elements 204 shown in a larger representation. The use of an alternative or supplemental graphical user interface (e.g., the second graphical user interface or zoom frame) may become desirable. In general, such second graphical user interface is a magnified version of some or all of the first graphical user interface. In order to actuate such second graphical user interface, the user should select a button, click a mouse, actuate a switch, implement an eye gaze function or otherwise indicate zoom selection via physical input to an electronic device.

Once initiated, a second user interface may be displayed to a user. In FIG. 2B, one exemplary embodiment 206 of a second user interface is shown as filling up the entire screen, and thus temporarily replaces or is displayed over the entire portion of the first graphical user interface. In FIG. 2C, another exemplary embodiment 208 of a second user interface is shown as displayed on top of a portion of the first graphical user interface 202.

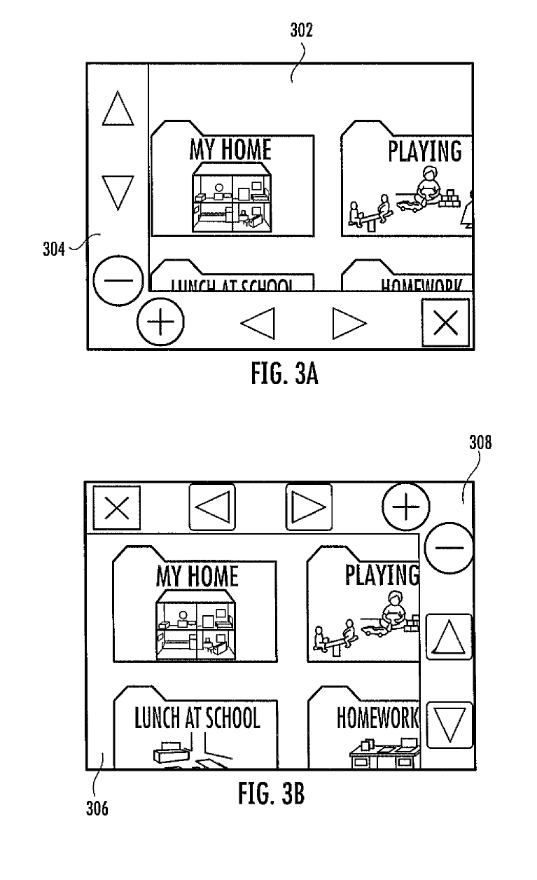

Once the zoom frame is initiated, it should be appreciated that user controls may also be available such as shown in the zoom toolbar portion 210 of second graphical user interface 206 in FIG. 2B. The zoom toolbar portion that provides selectable controls for the second user interface (i.e., zoom frame) may be configured in a variety of different positions. As shown in FIG. 2B, zoom toolbar 210 is configured to substantially surround the periphery of the second graphical user interface 206. Alternatively, a second graphical user interface may be configured along a portion of only one, two or more edges of the second graphical user interface. For example, as shown in FIG. 3A, a second graphical user interface 302 may have a zoom toolbar 304 configured along the bottom and left edges of the interface 302. In another example, as shown in FIG. 3B, a second graphical user interface 306 may have a zoom toolbar 308 configured along the top and right edges of the interface 306.

The various zoom toolbars shown in FIGS. 2B, 3A and 3B may include one or more selectable controls, which may be customized by a user. For example, a zoom toolbar may include a “zoom in” display element, such as represented by the (+) symbol in zoom toolbars 210, 304 and 308. A zoom toolbar may include a “zoom out” display element, such as represented by the (−) symbol in zoom toolbars 210, 304 and 308. A zoom toolbar may include a “cancel” button to dismiss the zoom frame and return to the original view (i.e. switch from the second graphical user interface back to the first graphical user interface). An example of a cancel button corresponds to the display element represented by the (X) symbol in zoom toolbars 210, 304 and 308. A zoom toolbar may include respective pan/scroll arrows for one or more directions of magnified movement relative to the first graphical user interface, such as represented by arrow symbols (←), (→), (↑) and (↓).

The provision of various selectable controls within a zoom toolbar portion of the zoom frame enables a user to continue to enlarge and move around the zoom frame until the user has a target in range and that target is as large as it needs to be. To assist with vision needs, the user can also set the zoom frame to have high contrast between background and the controls. If further customization is required, a user can set the background and control color to different options, depending on exact user preferences. As such, complete control of the zoom options is delivered to a user as part of the zoom frame itself. Control is provided even to such details as the customizable colors and position of the zoom frame.

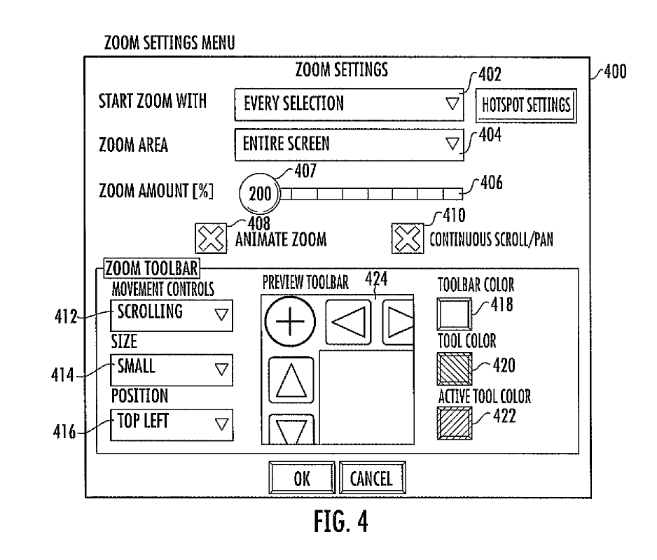

Additional controls, display options and other features of the zoom frame technology disclosed herein may be made available to a user by a zoom settings menu interface, such as shown in FIG. 4. The zoom settings menu interface 400, such as shown in FIG. 4, may be electronically displayed for a user upon initiation by selection from settings menus or other selectable display elements shown to a user.

A first display element corresponds to a “Start Zoom With” drop-down menu 402 by which a user may choose how often the zoom feature will be activated. Selectable options within the drop-down menu 402 may include: (1) “Every Selection”—Every selection activates the zoom; (2) “Zoom Hotspot”—Select a given predetermined screen location referred to as the Zoom Hotspot, and then the next user selection of the first graphical user interface activates the zoom; (3) “Secondary Blinking”—When eye tracking access control is used, a secondary blink while gazing at a certain display element or screen area activates the zoom; and (4) “Systems Menu Only”—The zoom is only activated when a user navigates the system menus. It does not zoom on pages or popups.

Referring still to FIG. 4, a second display element corresponds to a “Zoom Area” drop-down menu 404 by which a user may choose how much of the touch screen or other display device will show the magnified area. Selectable options within the drop-down menu 404 may include: (1) “Entire Screen”—Shows the magnification on the entire screen and displays the zoom toolbar; and (2) “Inset”—Shows the magnification on a small area of the screen.

The display options selectable from drop-down menu 404 can be appreciated from the example of FIGS. 2A-2C, in which FIG. 2A shows normal magnification associated with a first graphical user interface. FIG. 2B shows a zoomed second user interface when the “Entire Screen” option is selected from the “Zoom Area” drop-down menu 404 and a user selects the “my home” folder icon 405 in first graphical user interface 202. FIG. 2C shows a zoomed second user interface when the “Inset” option is selected from the “Zoom Area” drop-down menu 404 and a user selects the “my home” folder icon 405 in first graphical user interface area 202.

Referring still to FIG. 4, a Zoom Amount (%) slider display element 406 may also be provided within zoom settings menu interface 400. The slider display element 406 may be used to selectively adjust the initial magnification factor of the zoom. The slider thumb 407 may be moved to the right to increase the initial zoom, or the left to decrease the initial zoom upon initiation of the second user interface.

Additional selectable options may be available in the zoom settings menu interface 400, including but not limited to check boxes 408 and 410. Check box 408 corresponds to an “Animate Zoom” check box by which a user may select to show the screen objects enlarging as part of the zoom. Check box 410 corresponds to a “Continuous Scroll/Pan” check box, by which a user may select to have scrolling (or panning) in the Zoom Toolbar to continue until the user makes another selection. If check box 410 remains unselected, scrolling (or panning) will only move the zoomed area a small amount and then stop.

Additional controls within the zoom settings menu interface 400 include selectable options for the zoom toolbar. For example, the “Movement Controls” drop-down menu 412 provides a selectable list of display elements allowing the user to choose the controls to be displayed in the zoom toolbar. For example, controls may be selected from drop-down menu 412 for “Panning,” “Scrolling” or “Close Only.” When the Panning option is selected, the zoom toolbar may display buttons for increasing and decreasing the zoom amount (zoom in, zoom out) as well as arrows that will move the magnified area in the opposite direction of the arrows. When the Scrolling option is selected, the zoom toolbar may display buttons for increasing and decreasing the zoom amount (zoom in, zoom out) as well as arrows that will move the magnified area in the same direction of the arrows. When the Close Only option is selected, only the Cancel/dismiss control to exit the zoom frame will be displayed to a user. The difference between pan and scroll arrows may be represented, for example, in FIGS. 3A and 3B—one set of arrows (pan arrows of FIG. 3A) has triangles pointing in the various panning directions, while the other set of arrows (scroll arrows of FIG. 3B) has squares with internal triangles pointing in the various scrolling directions.

Referring still to the zoom toolbar controls of FIG. 4, a “Size” drop-down menu 414 enables a user to choose the margin size of the zoom toolbar and the corresponding size of the tools. A “Position” drop-down menu 416 enables a user to choose the relative position of the zoom toolbar, for example in any one of the four corners of the display device, or around the entire perimeter. A “Toolbar Color” box 418 may be provided by which a user may selectively choose the color of the zoom toolbar. A “Tool Color” box 420 may be provided by which a user may selectively choose the color of the tool being selected within the zoom toolbar. An “Active Tool Color” box 422 may be provided for a user to choose the color of the tool being selected within the Zoom toolbar. Selecting any of the color boxes 418, 420 and 422 will open a color selector menu, enabling a user to select or create a desired color from a plurality of predetermined or customizable choices. A preview window 424 may also be provided to display a preview of the zoom toolbar with changes as settings are selected within the zoom settings menu interface 400.

Referring now to FIG. 5, additional details regarding possible hardware components that may be provided to implement the various graphical user interface and zooming features disclosed herein are provided. FIG. 5 depicts an exemplary electronic device 500, which may correspond to any general electronic device including such components as a computing device 501, at least one input device (e.g., one or more of touch screen 506, microphone 508, peripheral device 510, camera 519 or the like) and one or more output devices (e.g., display device 512, speaker 514, a communication module or the like).

In more specific examples, electronic device 500 may correspond to a stand-alone computer terminal such as a desktop computer, a laptop computer, a netbook computer, a palmtop computer, a speech generation device (SGD) or alternative and augmentative communication (AAC) device, such as but not limited to a device such as offered for sale by DynaVox Mayer-Johnson of Pittsburgh, Pa. including but not limited to the V, Vmax, Xpress, Tango, M³ and/or DynaWrite products, a mobile computing device, a handheld computer, a mobile phone, a cellular phone, a VoIP phone, a smart phone, a personal digital assistant (PDA), a BLACKBERRY™ device, a TREO™, an Iphone™, an Ipod Touch™, a media player, a navigation device, an e-mail device, a game console or other portable electronic device, a combination of any two or more of the above or other electronic devices, or any other suitable component adapted with the features and functionality disclosed herein.

When electronic device 500 corresponds to a speech generation device, the electronic components of device 500 enable the device to transmit and receive messages to assist a user in communicating with others. For example, electronic device 500 may correspond to a particular special-purpose electronic device that permits a user to communicate with others by producing digitized or synthesized speech based on configured messages. Such messages may be preconfigured and/or selected and/or composed by a user within a message window provided as part of the speech generation device user interface. As will be described in more detail below, a variety of physical input devices and software interface features may be provided to facilitate the capture of user input to define what information should be displayed in a message window and ultimately communicated to others as spoken output, text message, phone call, e-mail or other outgoing communication.

Referring more particularly to the exemplary hardware shown in FIG. 5, a computing device 501 is provided to function as the central controller within the electronic device 500 and may generally include such components as at least one memory/media element or database for storing data and software instructions as well as at least one processor. In the particular example of FIG. 5, one or more processor(s) 502 and associated memory/media devices 504a, 504b and 504c are configured to perform a variety of computer-implemented functions (i.e., software-based data services). The one or more processor(s) 502 within computing device 501 may be configured for operation with any predetermined operating systems, such as but not limited to Windows XP, and thus is an open system that is capable of running any application that can be run on Windows XP. Other possible operating systems include BSD UNIX, Darwin (Mac OS X including “Cheetah,” “Leopard,” “Snow Leopard” and other variations), Linux, SunOS (Solaris/OpenSolaris), and Windows NT (XP/Vista/7).

At least one memory/media device (e.g., device 504a in FIG. 5) is dedicated to storing software and/or firmware in the form of computer-readable and executable instructions that will be implemented by the one or more processor(s) 502. Other memory/media devices (e.g., memory/media devices 504b and/or 504c) are used to store data which will also be accessible by the processor(s) 502 and which will be acted on per the software instructions stored in memory/media device 504a. Computing/processing device(s) 502 may be adapted to operate as a special-purpose machine by executing the software instructions rendered in a computer-readable form stored in memory/media element 504a. When software is used, any suitable programming, scripting, or other type of language or combinations of languages may be used to implement the teachings contained herein. In other embodiments, the methods disclosed herein may alternatively be implemented by hard-wired logic or other circuitry, including, but not limited to application-specific integrated circuits.

The various memory/media devices of FIG. 5 may be provided as a single portion or multiple portions of one or more varieties of computer-readable media, such as but not limited to any combination of volatile memory (e.g., random access memory (RAM, such as DRAM, SRAM, etc.)) and nonvolatile memory (e.g., ROM, flash, hard drives, magnetic tapes, CD-ROM, DVD-ROM, etc.) or any other memory devices including diskettes, drives, other magnetic-based storage media, optical storage media and others. In some embodiments, at least one memory device corresponds to an electromechanical hard drive and/or or a solid state drive (e.g., a flash drive) that easily withstands shocks, for example that may occur if the electronic device 500 is dropped. Although FIG. 5 shows three separate memory/media devices 504a, 504b and 504c, the content dedicated to such devices may actually be stored in one memory/media device or in multiple devices. Any such possible variations and other variations of data storage will be appreciated by one of ordinary skill in the art.

In one particular embodiment of the present subject matter, memory/media device 504b is configured to store input data received from a user, such as but not limited to data defining zoom frame settings or zoom frame actuation signals or zoom control signals. Such input data may be received from one or more integrated or peripheral input devices 510 associated with electronic device 500, including but not limited to a keyboard, joystick, switch, touch screen, microphone, eye tracker, camera, or other device. Memory device 504a includes computer-executable software instructions that can be read and executed by processor(s) 502 to act on the data stored in memory/media device 504b to create new output data (e.g., audio signals, display signals, RF communication signals and the like) for temporary or permanent storage in memory, e.g., in memory/media device 504c. Such output data may be communicated to integrated and/or peripheral output devices, such as a monitor or other display device, or as control signals to still further components.

Referring still to FIG. 5, central computing device 501 also may include a variety of internal and/or peripheral components in addition to those already mentioned or described above. Power to such devices may be provided from a battery 503, such as but not limited to a lithium polymer battery or other rechargeable energy source. A power switch or button 505 may be provided as an interface to toggle the power connection between the battery 503 and the other hardware components. In addition to the specific devices discussed herein, it should be appreciated that any peripheral hardware device 507 may be provided and interfaced to the speech generation device via a USB port 509 or other communicative coupling. It should be further appreciated that the components shown in FIG. 5 may be provided in different configurations and may be provided with different arrangements of direct and/or indirect physical and communicative links to perform the desired functionality of such components.

Various input devices may be part of electronic device 500 and thus coupled to the computing device 501. For example, a touch screen 506 may be provided to capture user inputs directed to a display location by a user hand or stylus. A microphone 508, for example a surface mount CMOS/MEMS silicon-based microphone or others, may be provided to capture user audio inputs. Other exemplary input devices (e.g., peripheral device 510) may include but are not limited to a peripheral keyboard, peripheral touch-screen monitor, peripheral microphone, mouse and the like. A camera 519, such as but not limited to an optical sensor, e.g., a charged coupled device (CCD) or a complementary metal-oxide semiconductor (CMOS) optical sensor, or other device can be utilized to facilitate camera functions, such as recording photographs and video clips, and as such may function as another input device. Hardware components of SGD 500 also may include one or more integrated output devices, such as but not limited to display 512 and/or speakers 514.

Display device 512 may correspond to one or more substrates outfitted for providing images to a user. Display device 512 may employ one or more of liquid crystal display (LCD) technology, light emitting polymer display (LPD) technology, light emitting diode (LED), organic light emitting diode (OLED) and/or transparent organic light emitting diode (TOLED) or some other display technology. Additional details regarding OLED and/or TOLED displays for use in SGD 500 are disclosed in U.S. Provisional Patent Application No. 61/250,274 filed Oct. 9, 2009 and entitled “Speech Generation Device with OLED Display,” which is hereby incorporated herein by reference in its entirety for all purposes.

In one exemplary embodiment, a display device 512 and touch screen 506 are integrated together as a touch-sensitive display that implements one or more of the above-referenced display technologies (e.g., LCD, LPD, LED, OLED, TOLED, etc.) or others. The touch sensitive display can be sensitive to haptic and/or tactile contact with a user. A touch sensitive display that is a capacitive touch screen may provide such advantages as overall thinness and light weight. In addition, a capacitive touch panel requires no activation force but only a slight contact, which is an advantage for a user who may have motor control limitations. Capacitive touch screens also accommodate multi-touch applications (i.e., a set of interaction techniques which allow a user to control graphical applications with several fingers) as well as scrolling. In some implementations, a touch-sensitive display can comprise a multi-touch-sensitive display. A multi-touch-sensitive display can, for example, process multiple simultaneous touch points, including processing data related to the pressure, degree, and/or position of each touch point. Such processing facilitates gestures and interactions with multiple fingers, chording, and other interactions. Other touch-sensitive display technologies also can be used, e.g., a display in which contact is made using a stylus or other pointing device. Some examples of multi-touch-sensitive display technology are described in U.S. Pat. No. 6,323,846 (Westerman et al.), U.S. Pat. No. 6,570,557 (Westerman et al.), U.S. Pat. No. 6,677,932 (Westerman), and U.S. Pat. No. 6,888,536 (Westerman et al.), each of which is incorporated by reference herein in its entirety for all purposes.

Speakers 514 may generally correspond to any compact high power audio output device. Speakers 514 may function as an audible interface for the speech generation device when computer processor(s) 502 utilize text-to-speech functionality. Speakers can be used to speak the messages composed in a message window as described herein as well as to provide audio output for telephone calls, speaking e-mails, reading e-books, and other functions. Speech output may be generated in accordance with one or more preconfigured text-to-speech generation tools in male or female and adult or child voices, such as but not limited to such products as offered for sale by Cepstral, HQ Voices offered by Acapela, Flexvoice offered by Mindmaker, DECtalk offered by Fonix, Loquendo products, VoiceText offered by NeoSpeech, products by AT&T's Natural Voices offered by Wizzard, Microsoft Voices, digitized voice (digitally recorded voice clips) or others. A volume control module 522 may be controlled by one or more scrolling switches or touch-screen buttons.

SGD hardware components also may include various communications devices and/or modules, such as but not limited to an antenna 515, cellular phone or RF device 516 and wireless network adapter 518. Antenna 515 can support one or more of a variety of RF communications protocols. A cellular phone or other RF device 516 may be provided to enable the user to make phone calls directly and speak during the phone conversation using the SGD, thereby eliminating the need for a separate telephone device. A wireless network adapter 518 may be provided to enable access to a network, such as but not limited to a dial-in network, a local area network (LAN), wide area network (WAN), public switched telephone network (PSTN), the Internet, intranet or ethernet type networks or others. Additional communications modules such as but not limited to an infrared (IR) transceiver may be provided to function as a universal remote control for the SGD that can operate devices in the user's environment, for example including TV, DVD player, and CD player.

When different wireless communication devices are included within an SGD, a dedicated communications interface module 520 may be provided within central computing device 501 to provide a software interface from the processing components of computer 501 to the communication device(s). In one embodiment, communications interface module 520 includes computer instructions stored on a computer-readable medium as previously described that instruct the communications devices how to send and receive communicated wireless or data signals. In one example, additional executable instructions stored in memory associated with central computing device 501 provide a web browser to serve as a graphical user interface for interacting with the Internet or other network. For example, software instructions may be provided to call preconfigured web browsers such as Microsoft® Internet Explorer or Firefox® internet browser available from Mozilla software.

Antenna 515 may be provided to facilitate wireless communications with other devices in accordance with one or more wireless communications protocols, including but not limited to BLUETOOTH, WI-FI (802.11b/g), MiFi and ZIGBEE wireless communication protocols. In general, the wireless interface afforded by antenna 515 may couple the device 500 to any output device to communicate audio signals, text signals (e.g., as may be part of a text, e-mail, SMS or other text-based communication message) or other electronic signals. In one example, the antenna 515 enables a user to use the device 500 with a Bluetooth headset for making phone calls or otherwise providing audio input to the SGD. In another example, antenna 515 may provide an interface between device 500 and a powered speaker or other peripheral device that is physically separated from device 500. The device 500 also can generate Bluetooth radio signals that can be used to control a desktop computer, which appears on the device's display as a mouse and keyboard. Another option afforded by Bluetooth communications features involves the benefits of a Bluetooth audio pathway. Many users utilize an option of auditory scanning to operate their device. A user can choose to use a Bluetooth-enabled headphone to listen to the scanning, thus affording a more private listening environment that eliminates or reduces potential disturbance in a classroom environment without public broadcasting of a user's communications, A Bluetooth (or other wirelessly configured headset) can provide advantages over traditional wired headsets, again by overcoming the cumbersome nature of the traditional headsets and their associated wires.

When an exemplary SGD embodiment includes an integrated cell phone, a user is able to send and receive wireless phone calls and text messages. The cell phone component 516 shown in FIG. 5 may include additional sub-components, such as but not limited to an RF transceiver module, coder/decoder (CODEC) module, digital signal processor (DSP) module, communications interfaces, microcontroller(s) and/or subscriber identity module (SIM) cards. An access port for a subscriber identity module (SIM) card enables a user to provide requisite information for identifying user information and cellular service provider, contact numbers, and other data for cellular phone use. In addition, associated data storage within the SGD itself can maintain a list of frequently-contacted phone numbers and individuals as well as a phone history or phone call and text messages. One or more memory devices or databases within a speech generation device may correspond to computer-readable medium that may include computer-executable instructions for performing various steps/tasks associated with a cellular phone and for providing related graphical user interface menus to a user for initiating the execution of such tasks. The input data received from a user via such graphical user interfaces can then be transformed into a visual display or audio output that depicts various information to a user regarding the phone call, such as the contact information, call status and/or other identifying information. General icons available on SGD or displays provided by the SGD can offer access points for quick access to the cell phone menus and functionality, as well as information about the integrated cell phone such as the cellular phone signal strength, battery life and the like.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of generating an interactive zoom interface for an electronic device, comprising:
electronically displaying a first graphical user interface area to a user;
receiving an electronic zoom actuation signal indicating a desire to initiate a magnified display state; and
displaying a second user interface area to a user upon receipt of the electronic zoom actuation signal;
wherein said second user interface area comprises a magnified view of at least one portion of said first user interface area, and wherein the magnification level of the second user interface is continuously adjustable while being displayed to a user.

2. The method of claim 1, wherein said second user interface area is displayed over the substantial entirety of the first user interface area.

3. The method of claim 1, wherein said second user interface area is displayed over a selected portion of the first user interface area.

4. The method of claim 1, wherein said second user interface area comprises a zoom toolbar portion having one or more selectable controls.

5. The method of claim 4, wherein said one or more selectable controls comprise one or more of a zoom in control, a zoom out control, a zoom amount control, pan direction controls, scroll direction controls, a cancel/dismiss control, contrast and display options controls, and zoom frame toolbar control, size color and position options controls.

6. The method of claim 4, wherein said zoom toolbar portion is configured in a location substantially surrounding the periphery of the second user interface area or along a portion of one, two or more edges of the second user interface area.

7. The method of claim 4, wherein said one or more selectable controls enable a user to continuously adjust the magnification level of the second user interface area relative to the first user interface area as well as the relative user location within the second user interface area.

8. The method of claim 1, further comprising a step of electronically verifying that the electronic device is operating in one of a plurality of given modes in which zoom frame features are available for presentation to a user.

9. A computer readable medium comprising computer readable and executable instructions configured to control a processing device to:
electronically display a first graphical user interface area to a user;
receive an electronic zoom actuation signal indicating a desire to initiate a magnified display state; and
display a second user interface area to a user upon receipt of the electronic zoom actuation signal;
wherein said second user interface area comprises a magnified view of at least one portion of said first user interface area, and wherein said second user interface area comprises a zoom toolbar portion having one or more selectable controls that enable a user to continuously adjust the magnification level of the second user interface area relative to the first user interface area as well as the relative user location within the second user interface area.

10. The computer readable medium of claim 9, wherein said second user interface area is displayed over the substantial entirety of the first user interface area.

11. The computer readable medium of claim 9, wherein said second user interface area is displayed over a selected portion of the first user interface area.

12. The computer readable medium of claim 9, wherein said one or more selectable controls comprise one or more of a zoom in control, a zoom out control, a zoom amount control, pan direction controls, scroll direction controls, a cancel/dismiss control, contrast and display options controls, and zoom frame toolbar control, size color and position options controls.

13. The computer readable medium of claim 9, wherein said zoom toolbar portion is configured in a location substantially surrounding the periphery of the second user interface area or along a portion of one, two or more edges of the second user interface area.

14. The computer readable medium of claim 9, wherein said executable instructions are further configured to control a processing device to electronically verify that the electronic device is operating in one of a plurality of given modes in which zoom frame features are available for presentation to a user.

15. An electronic device, comprising:
at least one electronic output device configured to display a first user interface area as visual output to a user;
at least one electronic input device configured to receive electronic input from a user corresponding to a zoom actuation signal indicating a desire to initiate a magnified display state;
at least one processing device;
at least one memory comprising computer-readable instructions for execution by said at least one processing device, wherein said at least one processing device is configured to receive the zoom actuation signal and initiate display of a second user interface area, wherein the second user interface area comprises an adjustably magnified view of at least one portion of said first user interface area.

16. The electronic device of claim 15, wherein said electronic device comprises a speech generation device that comprises at least one speaker for providing audio output.

17. The electronic device of claim 15, wherein said processing device is further configured to display the second user interface area over some or all of the first user interface area.

18. The electronic device of claim 15, wherein said processing device is further configured to incorporate a zoom toolbar portion having one or more selectable controls into a portion of the second user interface area.

19. The electronic device of claim 18, wherein said one or more selectable controls comprise one or more of a zoom in control, a zoom out control, a zoom amount control, pan direction controls, scroll direction controls, a cancel/dismiss control, contrast and display options controls, and zoom frame toolbar control, size color and position options controls.

20. The electronic device of claim 18, wherein said one or more selectable controls enable a user to continuously adjust the magnification level of the second user interface area relative to the first user interface area as well as the relative user location within the second user interface area.
